(19) United States
(12) Patent Application Publication
(10) Pub. No.: US 2016/0371245 A1
(43) Pub. Date: Dec. 22, 2016

(54) AUTOMATED DEVICE MANAGEMENT SYSTEM USING LOCAL AND NON-LOCAL FEEDS

(71) Applicant: Hartford Fire Insurance Company, Hartford, CT (US)

(72) Inventors: John R. Hamilton, Enfield, CT (US); Robert P. Wilson, III, Bristol, CT (US)

(21) Appl. No.: 14/746,189

(22) Filed: Jun. 22, 2015

(51) Int. Cl. G06F 17/24; H04L 29/12; G06K 15/02; G06K 15/00; G06T 11/20; G06F 3/0484

(52) U.S. Cl. CPC G06F 17/245; G06T 11/206; G06F 3/04842; G06K 15/02; G06K 15/402; H04L 61/2007; G06T 2200/24; H04L 61/6068

(57) ABSTRACT

Embodiments provide a system for managing and displaying data associated with a plurality of devices, including: a display device; a database for storing data associated with a plurality of devices; and a processor that executes a program of instructions to: receive, from one of: a local data source and a non-local data source, device identification data for each of the plurality of devices; receive, from at least one local data source and at least one non-local data source, a plurality of information characteristics for at least one of the plurality of devices; reconcile the plurality of information characteristics; compile the reconciled plurality of information characteristics into at least one data table; store, in the database, data associated with the plurality of devices, wherein the data comprises the device identification data and at least part of the at least one data table; and display, on the display device, a graphical user interface comprising the data.

### BACKGROUND

As technology becomes more ingrained in everyday life for individuals and businesses, companies are forced to buy more equipment to support this growing need. However, due to the high cost and short lifetime of such equipment (e.g., printers, telephones, computers, video equipment, etc.), more and more companies prefer to lease the equipment, rather than buy it outright. This presents an additional layer of complexity in determining which entity will be responsible for performing maintenance of that equipment. In some situations, the company leasing the equipment will be responsible for the maintenance, but more frequently it is the vendor who is responsible for all the maintenance.

This responsibility may include the responsibility to perform all preventative maintenance (e.g., performing software updates, replacing consumables, performing adjustments, etc.) and may also include fixing the equipment in the event of a malfunction. For companies with fewer pieces of equipment it may make sense for the company to call the vendor when maintenance needs to be performed. Some companies may prefer that the consumables be on a set delivery schedule, for example, consumables may be delivered every two months. However, if a company has a large amount of equipment that is leased, it may be unreasonable to expect the company to call the vendor when a piece of equipment malfunctions or when consumables need to be replaced.

One solution to this situation is that the vendor may have access to the equipment, for example, through a network connection. The vendor may then access the equipment from an off-site location and determine if the equipment is working properly or if the equipment needs preventative maintenance. This type of set-up may also notify the vendor automatically if a piece of equipment is malfunctioning. However, because the vendor accesses the equipment with little or no input from the company, it may be difficult for the company to ensure that the vendor is performing maintenance as necessary. Additionally, it may be difficult to ensure that services that the vendor has billed the company for are services that the vendor actually rendered. Therefore, there is a need for a management tool which allows a company to ensure that equipment is being serviced properly.

### BRIEF SUMMARY

In summary, an embodiment provides a system for managing and displaying data associated with a device. In an embodiment, a database stores data associated with a plurality of devices. In one embodiment, the database contains data obtained from at least one local data source and additionally contains data from a non-local data source.

The system includes a processor that executes a program of instructions to receive device identification data from one of the local or non-local data sources. In one embodiment this device identification data may include an internet protocol (IP) address. The system additionally receives at least one information characteristic for at least one of the plurality of devices. This information characteristic may be received from a local or non-local data source or may additionally be received from a plurality of data sources.

In one embodiment the system reconciles the at least one information characteristic and then compiles the reconciled information characteristic(s) into a one or more data tables. In one embodiment the compiled data and the device identification data may be displayed using a graphical user interface in a device manager application.

The graphical user interface may then allow a user to rearrange the display of the data. The graphical user interface may additionally comprise a plurality of view buttons which may allow a user to choose different views to display different data. This data may correspond to a particular device or may alternatively correspond to a group of devices.

In one embodiment a user may choose a capacity view which may display how much a particular device is being used. In an embodiment the graphical user interface may comprise a cost view which displays costs associated with the device. In an embodiment the graphical user interface may comprise a statistic view which may display a statistical analysis associated with the device identification data.

Additional embodiments are described, including other methods, as well as devices/apparatuses, systems including multiple devices, and products.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example data storage system.

FIG. 2 illustrates an example graphical user interface.

FIG. 3 illustrates another view within a graphical user interface.

FIG. 4A-4D illustrates example graphical displays with data for a particular device.

FIG. 5 illustrates an example statistical graph.

FIG. 6 illustrates an example system for managing devices using data from local and non-local feeds.

FIG. 7 illustrates an example method for managing devices using data from local and non-local feeds.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

An embodiment addresses the issues of providing vendor oversight and accountability for maintenance of equipment. As will become more apparent in the description of example embodiments, the discussed technological improvements offered by the various embodiments are applicable to a large variety of companies that lease equipment in which the vendor provides maintenance or services for that equipment.

Although various example embodiments are described with a focus on printer management, the principles and technological improvements offered may likewise be applied to various other equipment, for example, telephones, video equipment, computers, factory equipment, and the like, in which a vendor may be responsible for providing the services or maintenance. Thus, embodiments permit companies or other entities which may lease equipment or have vendor oversight of equipment to leverage external data sources, for example vendor supplied databases or third-party databases, and internal data sources, for example, user data and/or company specific data, in order to ensure that equipment is being serviced properly. Additionally, such a system may allow a company to determine needs for equipment. For example, a company could determine whether a piece of equipment is constantly in use which may indicate a need for additional pieces of equipment. On the other hand, a company may realize that a piece of equipment is never used and should be moved to a different location or taken out of service.

An embodiment utilizes a data driven approach to ensure that vendors are providing the services that are necessary and the services for which the company is being billed. An embodiment provides a system and method of managing large amounts of data relating to any and all pieces of equipment that a company may use. An embodiment may receive and process the data contained within multiple data sources, including local and non-local data sources, into a usable format which may allow a user and/or company to make determinations relating to a particular piece of equipment. The terms user and company may be used interchangeably throughout to increase readability. Once received and processed, an embodiment may provide a graphical user interface which allows the user to access the data related to a particular piece of equipment.

The data may be received from a variety of data sources. For example, data may include data from a non-local or external data source such as data received from a vendor. For example, a vendor may keep data in a database regarding equipment serviced by the vendor or leased by the company. The data may additionally include data from a local or internal data source, for example, data generated or gathered by the company. For example, this may include databases or reports regarding user information or device location data. As another option, the data source may include a third-party. The received data may be unique to a particular piece of equipment, or may include information for a plurality of devices. For example, an embodiment may retrieve all the data corresponding to a printer with a particular IP address, or may retrieve all the data corresponding to a group of printers on a particular network.

Once the data is received from one, some, or all of the data sources an embodiment may reconcile the data. For example, if the same or similar data has been received, an embodiment may determine what data is the most accurate. Once the data has been reconciled an embodiment may compile the data into one or more data tables. As an example, data relating to a particular characteristic may be compiled into one data table and data relating to another characteristic may be compiled into a different data table. These data tables may be stored within a central data location.

After compiling the data, an embodiment may display the data in a particular format. In one embodiment, the display of the data may be contained within a graphical user interface. The graphical user interface may then allow a user to interact with the data in order to view different data regarding a particular device or group of devices. For example, a user may select a particular device and access capacity information, unique device information (e.g., model, specifications, serial number, etc.), cost data associated with the particular device, user information associated with the device, location information, and a variety of other information.

One embodiment may additionally allow a user to compare the information compiled to other information. For example, a user may select a particular device and determine whether the device has had maintenance or requires maintenance. This data may then be compared against data received from the vendor to determine whether the vendor indicates that maintenance has been completed. In other words, an embodiment allows a company to audit the information received from a vendor to ensure that the company is being billed for work actually completed. A company may also use the information to request a new device if one is repeatedly malfunctioning or to verify information for devices on a network.

Embodiments represent a significant technical improvement to management of devices serviced by an outside entity. An embodiment is directed to substantially more than merely a computer implementation of a routine or conventional activity previously known in the industry as it significantly advances the technical efficiency, access, and/or accuracy of managing devices serviced by a vendor and ensures the integrity of billing and service work by the vendor by implementing a specific new method and system as defined herein.

An embodiment provides a specific advancement in the area of device management by providing technical benefits in data accuracy, data availability, and data integrity and such advances are not merely a longstanding commercial practice. The embodiments provide improvement beyond a mere generic computer implementation as they involve the compilation, processing, reconciliation, and conversion of significant amounts of data in a new beneficial manner as well as the interaction of a variety of specialized systems, networks, and subsystems.

For example, an embodiment facilitates the compilation and reconciliation of data associated with a particular device from a variety of data sources both local and non-local. In order to accomplish this, an embodiment identifies a unique identifier, for example, an IP address, media access control (MAC) address, serial number, unique name, and the like, used in the data sources in order to ascertain the data belonging to a particular device. Upon making this ascertainment, an embodiment offers a further technological advancement by reconciling the data between the multiple data sources. For example, an embodiment may receive data from dozens of data sources. Some of the data in the data sources may overlap with data from another data source. An embodiment may identify this overlap and determine which data is more likely to be accurate and may then use this data for further processing.

An embodiment additionally offers a further technological advancement by processing and manipulating the data into a format to be displayed to a user. An embodiment then allows a user the flexibility to view more information or sort and/or filter the data into different formats or views. Thus, embodiments provide the technology necessary to automate the manipulation of significant amounts of data from a large number of data sources to allow a company the ability to audit and ensure the vendor of devices is performing as expected.

The illustrated example embodiments will be best understood by reference to the figures. The following description is intended only by way of example, and simply illustrates certain example embodiments.

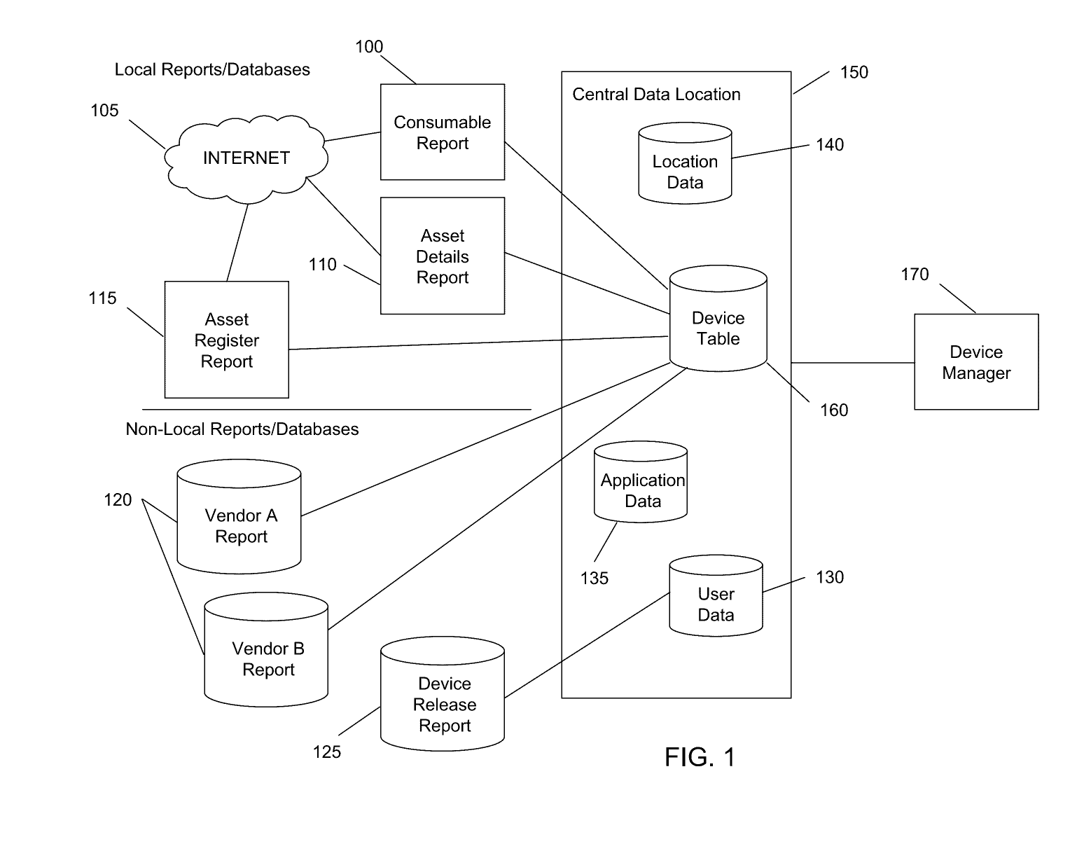

Referring to FIG. 1, an example company data storage system is shown. An embodiment may obtain data from a variety of data sources. The obtaining may include retrieving data from a particular source, for example, by polling the source or pulling data from the source. Alternatively or additionally, the obtaining may include receiving data from a source that uploads data to an embodiment. In other words, the obtaining of the data may be through active or passive data gathering. Some of the data sources may be local or internal to the company or may be received from a non-local or external data source, for example, from the device vendor or a third-party entity. In other words, some of the data sources may be stored or maintained by the company (i.e., a local data source). In the example of FIG. 1, a company may have data which may be accessible, for example through a file transfer protocol, through or stored on the internet 105 or local company network. In one embodiment, this information may be stored on a cloud storage device and accessed by an embodiment using the internet.

For example, a company may have a consumable report 100. Consumables may include accessories for a device which are required to be replaced periodically. For example, in the case of a printer, toner cartridges and paper may be considered consumables. The consumable report may include information regarding consumables for a device. For example, the consumables reports may indicate when a consumable was shipped, what consumable was shipped, when the consumable was shipped, where it was shipped, how many were shipped, and similar information related to consumables. The consumables report may be updated by the vendor, the company, a third-party, for example, a shipping company, or other source.

Other reports which may be stored on or accessible using the internet may include an asset details report 110 and asset register report 115. The asset details report may include information regarding a particular device, for example, the configuration of the device, the model number, serial number, IP address, and the like. The asset register report may include basic information about the equipment, for example, when it was installed, a company associated with the equipment, a description of the equipment, and the like.

Another data source may include a non-local or external report or database. These databases may include information sent to the company from an external source, for example, the vendor or a third-party. The databases may also be stored at the external source, for example, on the vendor's server, and accessible by an embodiment. Such non-local or external databases include vendor reports 120 and device release reports 125. The vendor reports may include information pulled from the device by the vendor. For example, a vendor may poll the device to verify the device is communicating with the network. Additionally, the vendor may poll the device to determine consumable's levels, for example, toner level on a printer. The vendor reports may additionally include information such as when maintenance was performed, expected maintenance schedule, and other vendor specific information. A vendor may have multiple reports that are provided. Alternatively or additionally, a company may have similar devices which are serviced by different vendors and may receive a report from each vendor.

Another type of external database may include a device release report 125. This may include user and/or job information for each job processed by the device. For example, a printer may store information regarding any print, scan, fax, or copy jobs that are performed on the printer. This database may be received from a third-party. For example, if a printer requires that a person swipe an employee badge to print, the company which keeps the badge data may provide the device release report. Even though listed as an external database, this database may also be an internal database kept by the company, for example, if device usage data is stored on an internal system rather than through a third-party.

A company may also have internal data stored, for example, within a central data location 150. Example internal databases include location data 140, application data 135, and user data 130. The location data 140 may include data regarding where a device is located within a particular location, network location data, street address information, and the like. The application data 135 may include information specific to the company, for example, policies and standards. For example, a company may have a policy that states if a printer has printed more than a million pages it should be replaced. The application data would include this rule for use in programming the device manager application 170. User data 130 may include some or all of the data included in the device release report 125 and may include additional information such as where the user is located, user full name, and the like. Device table 160 may include information relating to the device that may not be contained within another database. For example, this database may include information from the consumable report 100, asset details report 110, asset register report 115, vendor reports 120, and the like. As can be appreciated, different databases may be included and different configurations may be contemplated.

The databases, 130, 135, 140, and 160 within the central data location 150, may be used as master tables from which data for the device manager 170 may be pulled. These databases may contain the reconciled data or may alternatively provide a mechanism for reconciling the different information. For example, if a database receives data from multiple data sources, this information may overlap between the different data sources. As an example, a company may have two different databases which store user information. One of these databases may be accurate when a person is hired at the company but may not be updated regularly. The second database could be the information which is used to pay employees and would generally have updated information. However, this database may not contain information regarding all employees, for example, it may not have information associated with contractors because they are paid by the contracting company. Therefore, an embodiment may reconcile the information between the two data source. For example, if an address is provided for an employee but is different between the two data sources, an embodiment may recognize this difference and choose the address which is more likely to be accurate. Depending on the information, different data sources may have the most accurate information.

In determining the most accurate information, different data sources may be indicated as more accurate than others. For example, a user may indicate that data source A has the most accurate information, data source B should be used as a back up data source, and data source C may be used if no other source has the information. Another method for reconciling the information may be to use a statistical probability method. For example, if two out of three data sources have the same information, that information may be deemed to be most accurate since it is shared between more than one data source. Other methods of reconciling the information may be employed.

Once the data has been reconciled and compiled into the one or more master tables, an embodiment may display the device identification data and other information regarding the device in a device manager application 170.

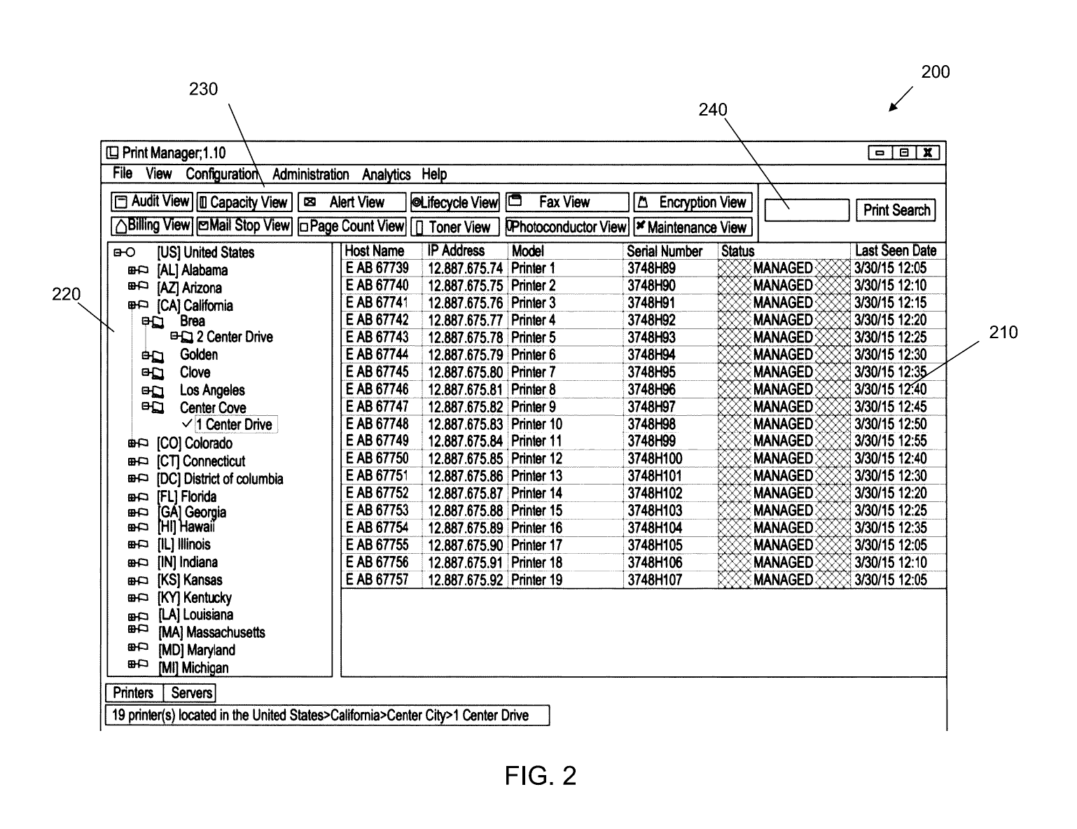

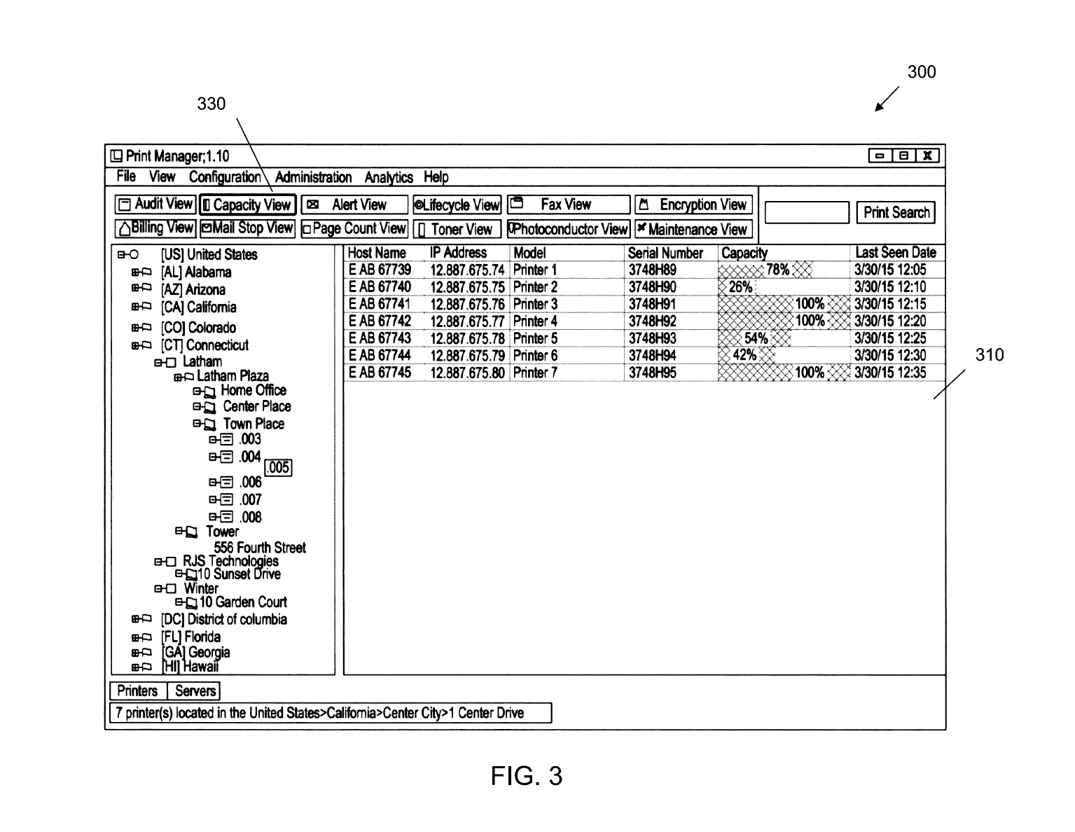

The device manager application 170 may be displayed as shown in FIG. 2 as a graphical user interface 200. The graphical user interface 200 may have different views and options for views. For example, a home type screen is shown in FIG. 2. Within the home screen is a display grid 210. This display grid may contain the data compiled from the different data sources as described in connection with FIG. 1. For example, the display grid may list the details of a particular printer. In the example in FIG. 2, the display grid 210 includes the host name, IP address, model, serial number, status, and last seen date of each particular printer. The information contained within the display grid may change depending on what information the user desires to see. For example, the graphical user interface 200 may include different view buttons 230. Upon selecting different views, for example, “Capacity View” a user may see different information. An example “Capacity View” screen is shown in FIG. 3.

The graphical user interface 300 in FIG. 3 is an example view of the “Capacity View” which has been selected from the view buttons 230 and 330. As is shown, the display grid 310 has updated to show the capacity information associated with a particular printer. This may indicate how much a particular printer is being used.

Referring back to FIG. 2, the graphical user interface 200 may additionally have a hierarchical tree 220. The hierarchical tree 220 may group different groups of devices. For example, the devices may be grouped by physical location, IP address range, identification data, or other types of groupings. The graphical user interface 200 may additionally include a search feature 240. This search feature may allow a user to enter different search terms to find a particular device. For example, a user may enter an IP address to find a particular device or a host name to find a particular group of devices.

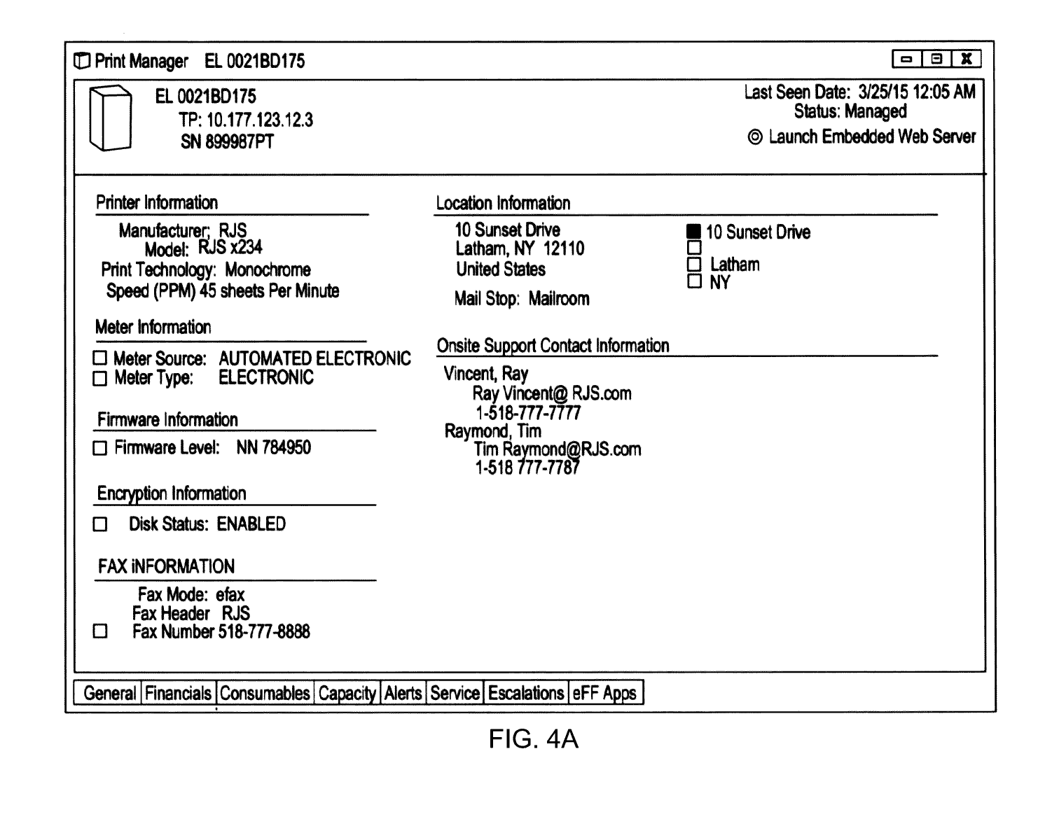

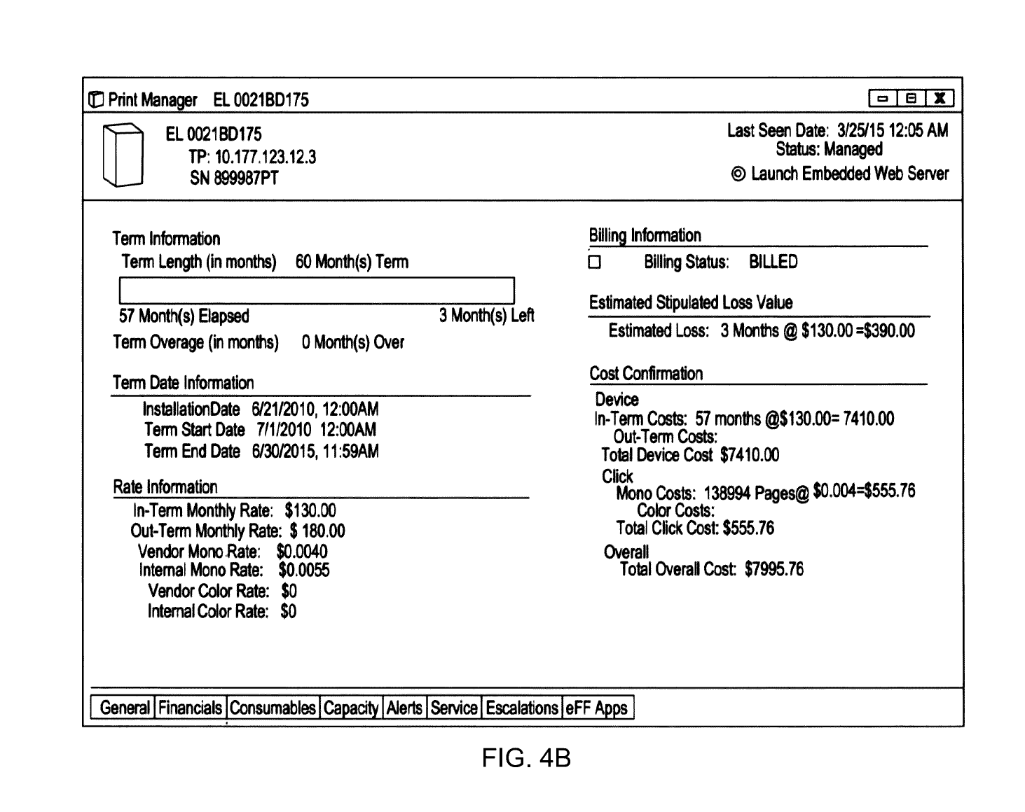

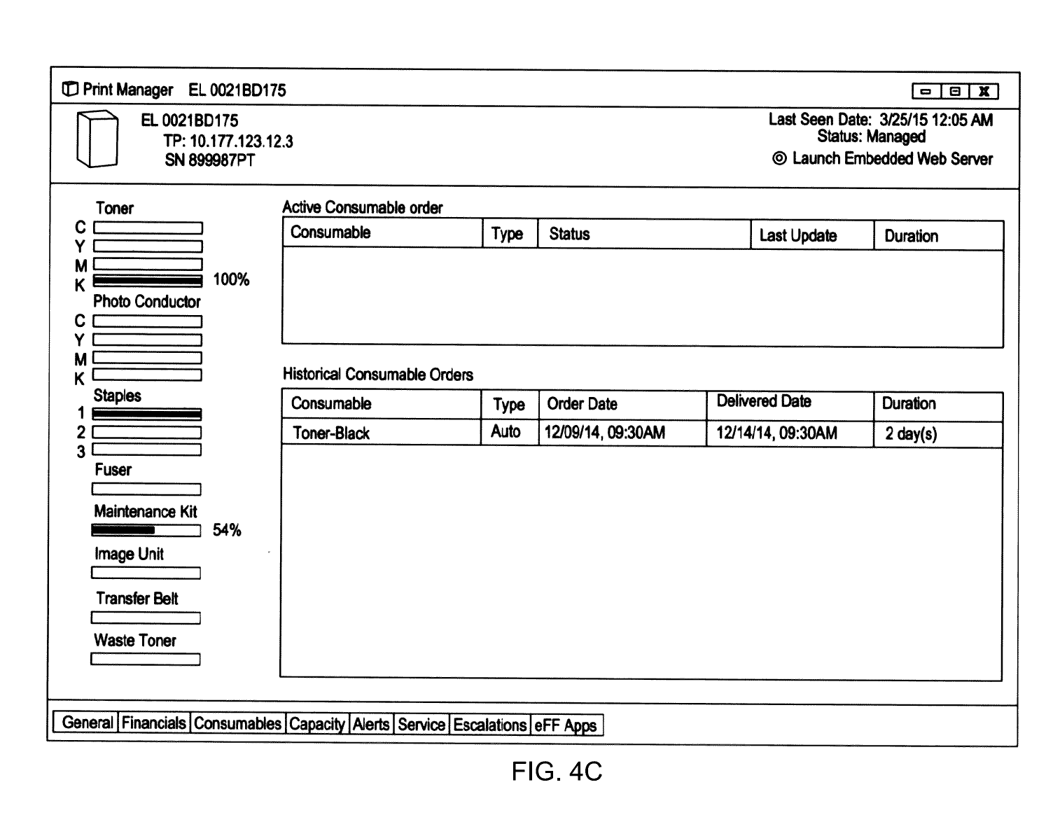

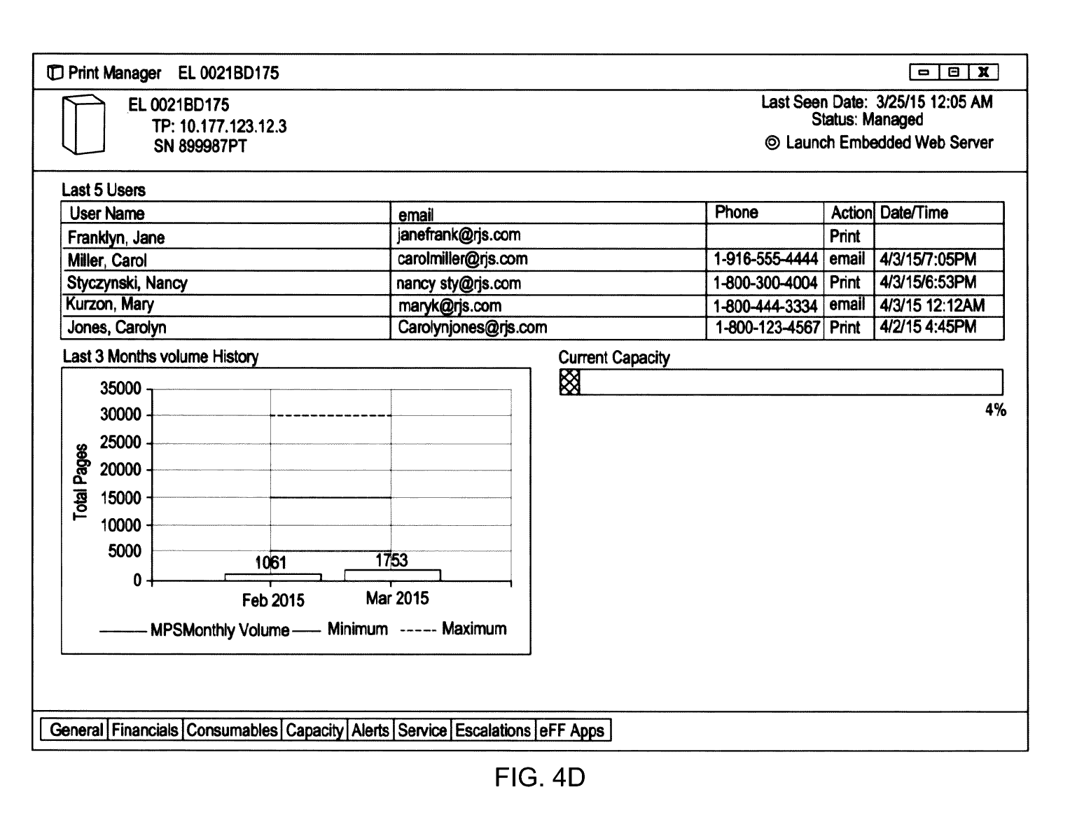

From the graphical user interface 200, the user may select a particular device. This selection may include the user double clicking a particular device, right clicking and selecting a menu option, or other methods of selection. This may open additional data about a particular device. FIG. 4(A-D) shows different examples of views that a user may see upon selection of a particular device. FIG. 4A shows an example general information tab which may include general information about the device (e.g., make, model, firmware, fax information, physical location, etc.). FIG. 4B shows an example financial information tab which may include information regarding the lease term, cost information, rate information, and the like. FIG. 4C shows an example consumables tab which may include information regarding the levels of the consumables, active consumable orders, historical consumable orders, and the like. FIG. 4D shows an example capacity tab which may include information about the last users, a historical volume use by month, current capacity, and the like.

Other views are available for viewing. One embodiment may have a maintenance view which may display information relating to a maintenance requirement or error associated with one or more of the devices. For example, if a printer is no longer communicating with the network, the maintenance view may show that the particular device is no longer communicating. The view may also designate when the device was last communicating and other information. Other types of maintenance requirements or errors may include time until preventative maintenance is to be performed, configuration errors, name mismatches, and the like. The maintenance view may also include a prioritization of the maintenance requirements. For example, one printer may be more important than another and that printer may then be listed as a higher priority than another printer. The prioritization may be performed manually by a user or may be performed automatically by the system based upon criteria.

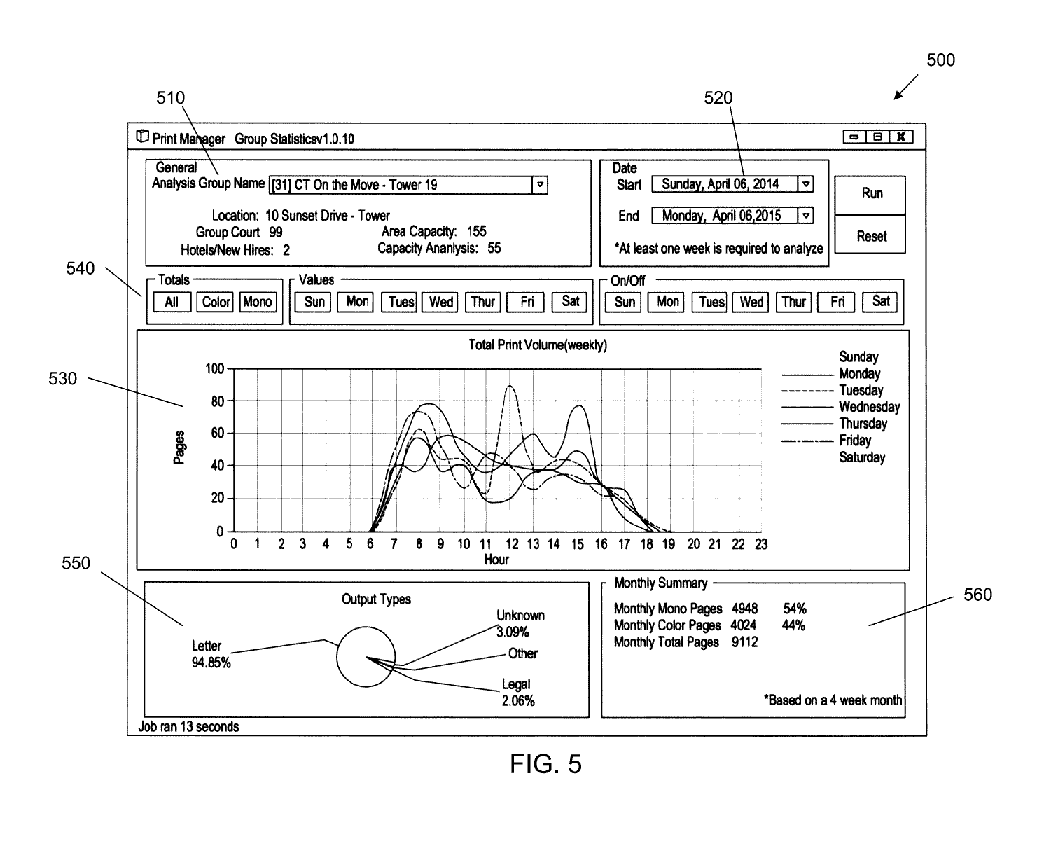

In one embodiment, statistical analysis can be completed. For example, such analysis may allow a company to analyze capacity and use of a particular device. This information may be useful to determine whether additional devices are needed, devices should be taken out of service, the type of jobs completed (e.g., black and white versus color printing, scanning versus faxing, etc.). FIG. 5 shows an example group statistic screen 500. The screen may include general group information in the general section 510. This information may include the group name that is being analyzed. Additionally, a user may graph the data by selecting a date range 520. Once these two things are selected the graph 530 will update with the desired information. A user may then change the view of the graph using the graph selection buttons/area 540. The group statistics screen 500 may include other areas which give a particular type of breakdown. For example, a user may wish to see the different types of output of the device. This information may be shown in a different graph in area 550. Additionally, the statistics screen 500 may include a summary area at 560.

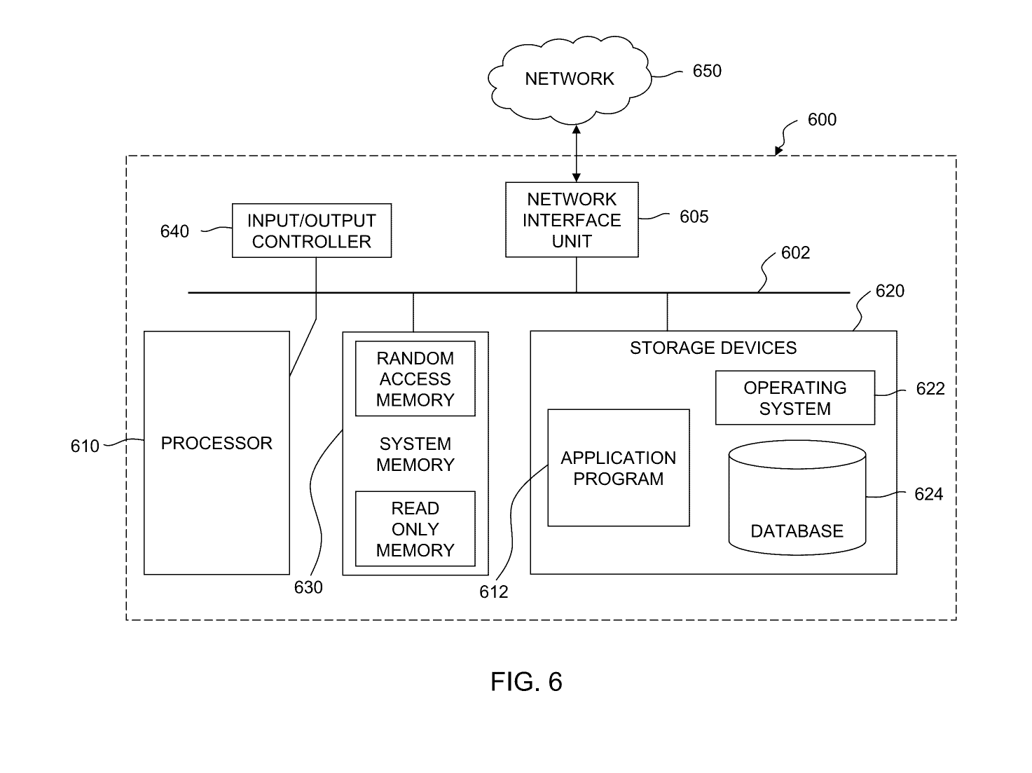

In the example of FIG. 6, a storage device 620 includes software such as a device manager application program 612 that may be run or executed by processor(s) 610 according to an operating system 622. The circuitry 600 provides that the processor loads the operating system 622 and thereafter the application program 610, e.g., into memory 630.

System 600 typically includes a network interface 605 facilitating communications with other devices, e.g., a connection to other devices over a network 650 using components such as a WWAN transceiver, a WLAN transceiver or a wired connection, e.g., a LAN connection. Commonly, system 600 will include an input/output controller 640 for data input and display. System 600 typically includes various memory 630 and storage devices 620, for example a database 624, e.g., for storing data from internal and external data sources, referred to herein.

Device circuitry, as for example outlined in FIG. 6, may be used to execute device management software as described herein. It will also be apparent that circuitry other than the non-limiting example outlined in FIG. 6 may be used.

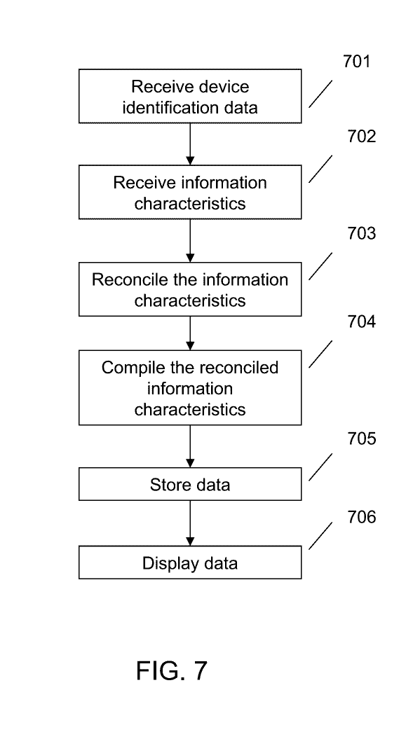

FIG. 7 shows an example method of managing devices using local and non-local data sources. At 701, an embodiment may receive device identification data for each of the plurality of devices within the company or connected to an embodiment. The device identification data may include any unique information which allows a device to be identified. For example, the device identification data may include an IP address, MAC address, unique name, serial number, and the like. The device identification data may be received from a local or non-local data source.

At 702, an embodiment may receive a plurality of information characteristics for each of the devices. The information characteristics may be associated with a device through the use of the device identification data. For example, each piece of information that is received may include the device identification data in order to correlate the information with the correct device. The information characteristics can include any type of information that can be associated with a device, for example, the information types that have been discussed previously regarding users, locations, devices, maintenance, costs, and the like. The information characteristics may be received from one or more of the data sources. For example, information characteristics may be received from a vendor report, internal database, third party source, and the like.

Upon receiving the information characteristics from the data sources, an embodiment may, at 703, reconcile the information characteristics. For example, the data sources may contain overlapping information. In other words, one data source may have data relating to the location of a device and another data source may similarly have data relating to the location of a device. However, these data sources may not have the same information, so an embodiment may reconcile the information. In reconciling the information, an embodiment may identify which data source is most likely to be accurate and then use this information. The identification of the most accurate data source may be predetermined by a user, or an embodiment may make a determination using an analysis technique.

Once the data has been reconciled, an embodiment, at 704, may compile the reconciled data into at least one data table as described in connection with FIG. 1. The data table(s) may act as a master table which may be determined to be the overriding and accurate information for any future actions. The compiling may also include filtering and sorting the reconciled data for easier access. At 705, an embodiment may store data associated with the plurality of devices in a database. The data may include the device identification data received at 701 and at least some of the information characteristics received at 702 and subsequently reconciled at 703.

At 706 an embodiment may display a graphical user interface. The display of this data does not necessarily, and preferably does not, comprise just displaying the master tables. Rather, in one embodiment, the data is displayed in a graphical user interface as described and shown in connection with FIGS. 2-5. The graphical user interface may comprise the data in its entirety or just portions of the data. The amount and type of information displayed in the graphical user interface may change depending on which view is chosen by the user, as seen in FIGS. 2-5.

In one embodiment once the data has been processed, an embodiment may compare the processed data to data obtained from an external source. For example, the data may be compared with maintenance data for a particular device from a vendor. In this way, a company can determine if the vendor is performing service per the service agreement and whether the company is being billed for service that is not being completed. In other words, the system described herein allows a company to verify the integrity of the information received from a vendor. Additionally, the system described herein, allows a company to verify device information to ensure that the vendor has the latest information, for example, if a device is moved from one location to another. The system also allows a company to determine different statistics associated with a particular device to determine if there is a need for additionally devices or whether a device is underused and should be taken out of service.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

Any combination of one or more non-signal device(s) may be utilized. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage medium is not a signal and “non-transitory” includes all media except signal media.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of an information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A system for managing and displaying data associated with a plurality of printers, comprising:
a display device;
a database for storing data associated with a plurality of printers; and
a processor that executes a program of instructions to:
receive, from one of: a local data source and a non-local data source, device identification data for each of the plurality of printers;
receive, from at least one local data source and at least one non-local data source, a plurality of information characteristics for at least one of the plurality of printers;
reconcile the plurality of information characteristics;
compile the reconciled plurality of information characteristics into at least one data table;
store, in the database, data associated with the plurality of printers, wherein the data comprises the device identification data and at least part of the at least one data table; and
display, on the display device, a graphical user interface comprising the data.

2. The system of claim 1, further comprising at least one printer.

3. The system of claim 1, wherein the device identification data comprises an internet protocol address.

4. The system of claim 1, wherein the graphical user interface comprises a plurality of view buttons, wherein a view button allows a user to select a view in which the data is sorted and filtered based upon the view selected.

5. The system of claim 4, wherein the view comprises a maintenance view, wherein the maintenance view displays information relating to a maintenance requirement of at least one printer.

6. The system of claim 4, wherein the view comprises a capacity view, wherein the capacity view displays how much at least one printer is being used.

7. The system of claim 4, wherein the view comprises a statistics view, wherein the statistics view displays a statistical analysis associated with the data.

8. The system of claim 4, wherein the view comprises a cost view, wherein the cost view displays the costs associated with at least one printer.

9. A system for managing and displaying data associated with a plurality of devices, comprising:
a display device;
a database for storing data associated with a plurality of devices; and
a processor that executes a program of instructions to:
receive, from one of: a local data source and a non-local data source, device identification data for each of the plurality of devices;
receive, from at least one local data source and at least one non-local data source, a plurality of information characteristics for at least one of the plurality of devices;
reconcile the plurality of information characteristics;
compile the reconciled plurality of information characteristics into at least one data table;
store, in the database, data associated with the plurality of devices, wherein the data comprises the device identification data and at least part of the at least one data table; and
display, on the display device, a graphical user interface comprising the data.

10. The system of claim 9, further comprising at least one device.

11. The system of claim 9, wherein the device identification data comprises an internet protocol address.

12. The system of claim 9, wherein the graphical user interface comprises a plurality of view buttons, wherein a view button allows a user to select a view in which the data is sorted and filtered based upon the view selected.

13. The system of claim 12, wherein the view comprises a maintenance view, wherein the maintenance view displays information relating to a maintenance requirement of at least one device.

14. The system of claim 12, wherein the view comprises a capacity view, wherein the capacity view displays how much at least one device is being used.

15. The system of claim 12, wherein the view comprises a statistics view, wherein the statistics view displays a statistical analysis associated with the data.

16. The system of claim 12, wherein the view comprises a cost view, wherein the cost view displays the costs associated with at least one device.

17. A computerized method for managing and displaying data associated with a plurality of devices, comprising:
receiving, from one of: a local data source and a non-local data source, device identification data for each of the plurality of devices;
receiving, from at least one local data source and at least one non-local data source, a plurality of information characteristics for at least one of the plurality of devices;
reconciling the plurality of information characteristics;
compiling the reconciled plurality of information characteristics into at least one data table;
storing, in a database, data associated with the plurality of devices, wherein the data comprises the device identification data and at least part of the at least one data table; and
displaying, on a display device, a graphical user interface comprising the data.

18. The computerized method of claim 17, wherein the device identification data comprises an internet protocol address.

19. The computerized method of claim 17, wherein the plurality of data sources comprises at least one of: the first data source and the second data source.

20. The computerized method of claim 17, wherein the graphical user interface comprises a plurality of view buttons, wherein a view button allows a user to select a view in which the device identification data and at least part of the at least one data table is sorted and filtered based upon the view selected.
